(19) United States
(12) Patent Application Publication
(10) Pub. No.: US 2002/0101944 A1
(43) Pub. Date: Aug. 1, 2002

(54) Process for digital message transmission, and a receiver

(75) Inventors: Stefan Schabel, Niederstotzingen (DE); Wolfram Lautenschlager, Sachsenheim (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/036,391

(22) Filed: Jan. 7, 2002

(30) Foreign Application Priority Data
Jan. 8, 2001 (DE) 101 00 500.8

(51) Int. Cl. H04B 1/10

(52) U.S. Cl. 375/350

(57) ABSTRACT

A process for digital message transmission is specified, in which the transmitted signals are sampled at the end of a transmission link by means of a device for timing recovery and are then further processed. In this case the signals are fed to a discriminator simultaneously via two separate paths, a delay path and a path fitted with a filter. A wideband bandpass filter with a relative bandwidth of 0.2% to 0.4% of the bit timing of the transmitted signals is used as a filter, whose transient recovery time is less than the time by which the signals are delayed on the delay path, which in turn is less than the decay time of the bandpass filter. An amplifier limiting the amplitude of the output voltage of the same limiting amplifier via which the timing signals are brought to the required constant level, is connected downstream of the bandpass filter.

### BACKGROUND OF THE INVENTION

The invention is based on a priority application DE 101 00500.8 which is hereby incorporated by reference. The invention refers to a process for digital message transmission in the packet mode, in which process the transmitted signals are sampled at the end of a transmission link by means of a device for timing recovery and are then further processed, and in which process the signals are fed to a discriminator simultaneously via two separate paths, a delay path and a path fitted with a filter (DE book “Digital and Analogue Message Transmission” by Erich Pehl, Verlag Hüthig, Heidelberg, 1998, pages 182, 183). The invention furthermore refers to an optical receiver in a telecommunication system in which optical data packets are transmitted.

In the case of sequential transmission of digital signals over lines, the frequency and phase of the receiver timing —the local timing—has to be adjusted to the timing of the incoming signals. This is necessary because, due to variation in the transfer function of the transmission channel, not only is the shape of the received signals (pulses) modified, but also because the time position of the respective pulse maximum is displaced. The overall pulse shaping is also influenced by temperature drift and tolerances of the components used in the transmitter and receiver or of the cable used as the transmission medium. The pulse shaping is therefore time-dependent and subject to a certain statistical variation. The ratio between the useful signal and the noise signal (signal-to-noise ratio) and with it the achievable bit error rate substantially depends on the influencing variables as described. In all cases it must be ensured that a further processed variable is obtained during sampling of the signals arriving at the receiver, which guarantees a bit error rate that does not exceed a specified limit.

According to the DE book by Erich Pehl mentioned at the outset, the timing can be recovered for example from a continuous data signal by using a narrow-band filter. In another of these processes a phase-controlled oscillator (PLL circuit) is used. In packet switched networks (burst mode) in which the data are compressed into bursts, there are data-free pauses and the burst can come from different transmitters. They can therefore have totally different phases. For timing recovery in networks with burst operation the above-mentioned methods are too slow and therefore unsuitable.

### SUMMARY OF THE INVENTION

The object of the invention is to further develop the process described at the outset so that it can also be used for a digital message transmission with burst operation.

This object is achieved according to the invention in that

a wideband bandpass filter with a relative bandwidth of 0.2% to 0.4% of the bit timing of the transmitted signals is used as a filter, whose transient recovery time is less than the time by which the signals are delayed on the delay path, which in turn is less than the decay time of the bandpass filter, and

an amplifier limiting the amplitude of the output voltage of the same limiting amplifier via which the timing signals are brought to the required constant level, is connected downstream of the bandpass filter.

In this process, as before, the incoming signal is split into two separate paths. In one path is the wideband bandpass filter that filters out the timing oscillation from the composite signals. The filtered signal is then conditioned by the limiting amplifier. The transient recovery time of the bandpass filter at the start of the burst is less than the decay time or hold time after the end of the burst. At the end of the delay path the signals are delayed by a constant time that is less than the transient recovery time of the bandpass filter, but greater than its decay time. Under these conditions, during the entire burst period an in-phase timing signal is available at the discriminator at an easily evaluated level.

In a preferred embodiment, the wideband bandpass filter uses a clocked bandpass filter. The signal to be filtered is multiplied in two analogue multipliers, on the one hand with the local timing and on the other hand with the local timing shifted by 90°. At the output of the multiplier, real and imaginary parts of the complex envelope curves of the signal are available as two low-frequency signals. The two envelope signals are band-limited by two identical low-pass filters. At their outputs, the now band-limited envelope is again multiplied by the local timing or the local timing shifted by 90°, respectively, and summed to an output signal.

### BRIEF DESCRIPTION OF THE DRAWINGS

The process according to the invention is described as an exemplary embodiment with the aid of the drawings, in which:

FIG. 1 shows a schematic representation of a circuit belonging to a receiver in the digital message transmission system.

FIG. 2 shows an extended embodiment compared to FIG. 1.

FIG. 3 shows an enlarged representation of a detail of the circuit shown in FIG. 1 or FIG. 2.

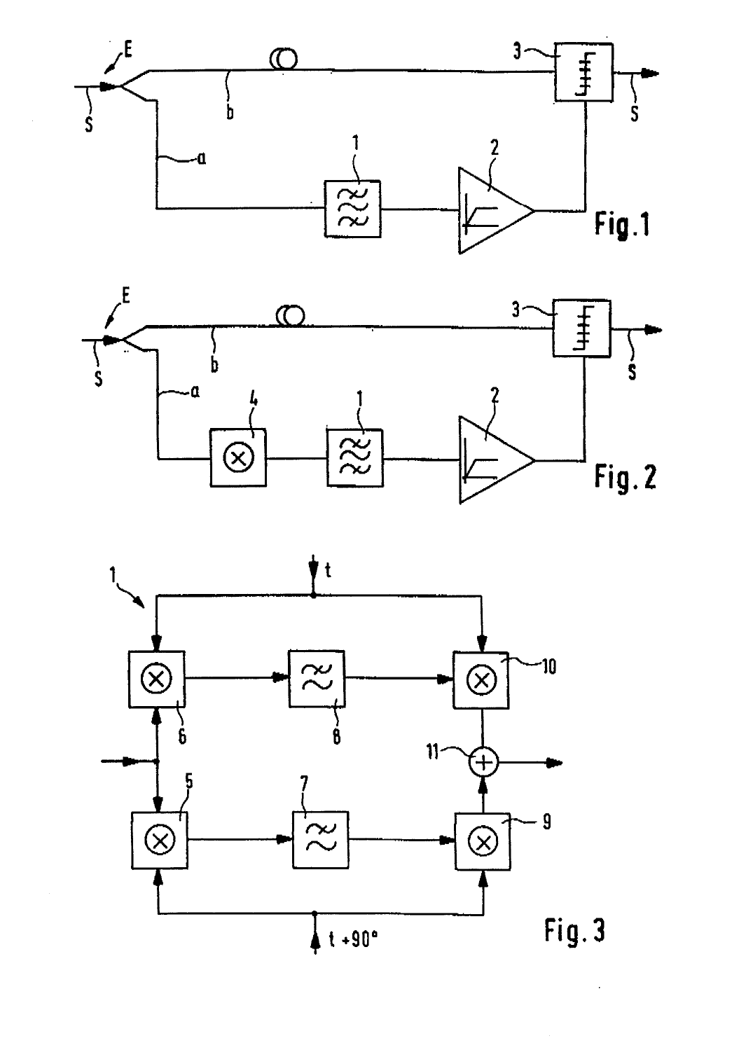

A signal stream S consisting of bursts is applied to the input E of a receiver for signals of the digital message transmission. The signal stream S is split at the output E onto a path a and a delay path b denoted by two loops. A wideband bandpass filter 1 and a limiting amplifier 2 are arranged in path a. The delay path b and the output of the amplifier 2 are connected to a discriminator 3 at whose output the regenerated signal stream S is available.

The bandwidth of the bandpass filter 1 is chosen in relation to the bit timing of the signal stream to be received. A parameter for this is the filter quality factor Q, which should lie between 300 and 400. That corresponds to a relative bandwidth of around 0.3% of the bit timing. For a signal stream with a bit timing of 10 Gbit/s this therefore amounts to approximately 30 MHz. In this context, the bandwidth of the bandpass filter 1 is chosen so that it lies between 0.2% and 0.4% of the bit timing of the signal stream to be received.

As soon as a burst of the signal stream S is applied to the bandpass filter 1, the latter begins to operate. At the start of the burst it has a transient recovery time TE, after which a usable timing signal is delivered by the bandpass filter 1. The signal (burst) fed onto the delay path b is delayed by a time TV that is longer than the transient recovery time TE. At the end of the burst, the bandpass filter 1 has a decay time TA, after which no further timing signal is delivered. Only at the arrival of the next burst of the signal stream S does the bandpass filter 1 again deliver a timing signal—as described. Since the signal on the delay path b is delayed by the time TV, the decay time TA of the bandpass filter 1 must be greater than the time TV.

In order to realise the stated times in the manner as described —TE<TV<TA— and to avoid the effects of amplitude fluctuations of the voltage at the output of the bandpass filter 1, the limiting amplifier 2 is connected to said bandpass filter. The filtered timing signal delivered by the bandpass filter 1 is conditioned by the amplifier 2. In the preferred embodiment its threshold value is chosen so that the limiting of the timing signal comes into effect at less than ¼ of the maximum amplitude at the output of the bypass filter 1. As a result, the transient recovery time TE of the bandpass filter 1 is set considerably shorter than its decay time TA. On the other hand, the amplifier 2 boosts the level of the timing signal to a value that can be used for further processing. The timing signal is output by the amplifier 2 to the discriminator 3, at which, due to the condition TE<TV<TA, an in-phase timing signal is available during the entire duration of the burst.

If the received signal stream is coded with an NRZ (non-return-to-zero) code, a converter 4 (FIG. 2) by which the NRZ code is converted to a RZ code, is inserted in the path a. The clock frequency of the signal stream is thus reproduced as a spectral component in the signal stream.

Furthermore, to prevent data flow-dependent timing failures occurring, it is useful to ensure that the decay time TA is longer than the maximum permitted or expected constant 0 or constant 1 sequence in the signal stream. That can be achieved if the quality factor Q of the bandpass 1 is greater than:

Q=2 [symbol] N/In(Uₘₐₓ/2Uₗᵢₘᵢₜ)

where:

N the maximum expected length of a 0 or 1 sequence

Uₘₐₓ the maximum level at the output of the bandpass filter 1 in the presence of a 0101 sequence

Uₗᵢₘᵢₜ the limiting voltage to fully drive the amplifier 2.

In the preferred embodiment a clocked bandpass filter is used as the bandpass filter 1, as illustrated in FIG. 3, for example.

The signal to be filtered is multiplied in two analogue multipliers 5 and 6 with the local timing t on the one hand and the local timing t shifted by 90° on the other hand. Real and imaginary parts of the complex envelopes of the input signals are available at the output of the multipliers 5 and 6 as two low-frequency signals. These two signals are band-limited by two identical low-pass filters 7 and 8. At their outputs the signals are again multiplied by the timing t or the timing t shifted by 90° in analogue multipliers 9 and 10 and summed to the output signal in a summing unit 11, which output signal is fed to the amplifier 2.

This clocked bandpass filter behaves like a bandpass filter with the local timing t as centre frequency and a bandwidth that is equal to the cut-off frequency of the two low-pass filters 7 and 8. Although the output signal is generated from the local timing t, its frequency and phase coincide with the input signal if the deviation between input frequency and local clock frequency lies within the set bandwidth.

The multipliers 5 and 6 and 9 and 10, respectively, can be implemented by fast diode mixers. The cut-off frequency of the low-frequency signals falls with increasing quality factor Q and can be processed by means of fast operational amplifiers.

Due to the use of sample-and-hold elements, the bandwidth of the bandpass filter 1 in FIG. 3 can be modified. If required, these sample-and-hold elements can be arranged upstream of the low-pass filters 7 and 8 in the direction of transmission. Such sample-and-hold elements can result in a relatively wide bandwidth at the start of the burst for fast transient conditions (short transient recovery time TE) and consequently provide a long decay time TA by switching to a narrow or zero bandwidth. This then produces only a small dependency of the timing signal on the signal content.

1. Process for digital message transmission in the packet mode, in which process the transmitted signals are sampled at the end of a transmission link by means of a device for timing recovery and are then further processed, and in which process the signals are fed to a discriminator simultaneously via two separate paths, a delay path and a path fitted with a filter, wherein
a wideband bandpass filter with a relative bandwidth of 0.2% to 0.4% of the bit timing of the transmitted signals is used as a filter, whose transient recovery time is less than the time by which the signals are delayed on the delay path, which in turn is less than the decay time of the bandpass filter, and
an amplifier limiting the amplitude of the output voltage of the same limiting amplifier via which the timing signals are brought to the required constant level, is connected downstream of the bandpass filter.

2. Process according to claim 1, wherein a bandpass filter with a relative bandwidth of 0.3% of the bit timing of the transmitted signals is used.

3. Process according to claim 1, wherein
a circuit with two parallel paths in which each is an identical low-pass filter arranged between two analogue multipliers, is used as the bandpass filter, and
the local timing is applied to the multipliers of the one path, while the local timing shifted by 90° is applied to the multipliers of the other path.

4. Process according to claim 3, wherein a sample-and-hold element is inserted in each case in the direction of transmission prior to the low-pass filters.

5. Process according to claim 1, wherein the coding of the signals prior to the bandpass filter is converted from an NRZ code to an RZ code.

6. Receiver for an optical telecommunications system for the transmission of optical data packets, wherein
a wideband bandpass filter with a relative bandwidth of 0.2% to 0.4% of the bit timing of the transmitted signals is used as a filter, whose transient recovery time is less than the time by which the signals are delayed on the delay path, which in turn is less than the decay time of the bandpass filter, and
wherein an amplifier limiting the amplitude of the output voltage of the same limiting amplifier via which the timing signals are brought to the required constant level, is connected to the bandpass filter.
